(19) United States
(12) Patent Application Publication
(10) Pub. No.: US 2025/0098603 A1
(43) Pub. Date: Mar. 27, 2025

(54) SELF-PROPELLED DEVICE FOR IRRIGATING LAND AREAS

(71) Applicant: SEED2SOIL GMBH & CO. KG, Weifelstede (DE)

(72) Inventors: Justus Lange, Celle (DE); Malte Hamann, Edewecht (DE); Florian Lücking, Godensholt (DE); Michael Pokriefke, Hude (DE)

(21) Appl. No.: 18/886,795

(22) Filed: Sep. 16, 2024

(30) Foreign Application Priority Data
Sep. 22, 2023 (EP) EP23199137.3

(51) Int. Cl. A01G 25/09

(52) U.S. Cl. CPC A01G 25/095

(57) ABSTRACT

A self-propelled device for irrigating land areas, having a frame, a running gear, a drive device, a water supply that has a supply hose that is at least partially wound on a rotatably mounted hose drum and which is connected to a water inlet at a first end, and to a dispensing line that is rotatably mounted and connected to the water supply at a second end, and having a number of nozzles for irrigating land areas, which are connected to the dispensing line and disposed at a mutual spacing. The device is provided with a rotationally driven dispensing line that is held by a support frame assembly and displaceable in a reciprocating manner between a use position and a transport position.

### CROSS REFERENCE TO RELATED APPLICATIONS

This application claims priority under 35 U.S.C. § 119 to German Patent Application DE 23 199 137.3, filed Sep. 22, 2023, which is herein incorporated by reference in its entirety, including without limitation, the specification, claims, and abstract, as well as any figures, tables, appendices, or drawings thereof.

### FIELD OF THE INVENTION

The present invention relates to a self-propelled device for irrigating land areas.

### BACKGROUND OF THE INVENTION

The background description provided herein gives context for the present disclosure. The work of the presently named inventors, as well as aspects of the description that may not otherwise qualify as prior art at the time of filing, are neither expressly nor impliedly admitted as prior art.

Known from document DE 2 209 702 A1 is a generic autonomously traveling irrigation apparatus. The supply hose, which is wound on the hose drum, is connected to a water supply by way of a first end of said supply hose. Thereafter, the device is moved across the land area to be irrigated, whereby the supply hose is successively drawn off the hose drum and deposited on the ground. The irrigation apparatus is stopped as soon as the end of the land area to be irrigated is reached, or the supply hose has been completely drawn off the hose drum. Thereafter, the water flow is switched on and the device moves back to the initial position along the supply hose while distributing water. Generic irrigation apparatuses, in most instances, have two irrigators, a first one for driving the hose drum and a second for distributing the major quantity of the water. The first irrigator has a rigid self-supporting dispensing line, one nozzle being disposed on each end of the latter. During the return travel, the dispensing line rotates about a vertical axis in a plane above the hose drum. Water that has been pumped into the support frame assembly by way of the supply hose exits through nozzles disposed on the end of the dispensing line. Based on the principle of repulsion, water exiting through the nozzles drives the dispensing line in the rotating direction. The first irrigator is connected to the rotational axis of the hose drum by way of the rotation axis and by way of a gear unit and drives said hose drum during the return travel so as to wind up the hose. In order to generate a sufficient propulsion pulse, the nozzles are aligned in a direction which is opposite to the rotating direction of the dispensing line. The length of the dispensing line is limited because the propulsion output of the nozzles operating according to the principle of repulsion reaches a point at which said propulsion output is insufficient for moving the weight that has increased proportionally with the increased length. As the length of the dispensing line increases, the material of the self-supporting tube used also sags at the outer ends to an extent that the tubular ends scrape along the ground and, as a result, block any rotating movement. The first irrigator is not suitable for use with large working widths, because the energy stored in the water is used for the drum drive, thus limiting the range of the trajectory of the exiting water. The second irrigator is a long-range irrigator for achieving a large working width. In order to achieve the large working width, this second irrigator is operated at water pressures of more than 5 bar.

Known from EP 0 604 682 A1 is a device for irrigating agricultural land areas, which has a support frame assembly that is movable in a reciprocating manner in a pendular movement of approximately 60° about the vertical axis. The support frame assembly protrudes highly upward. The water supply does not take place by way of a supply hose which is wound on a hose drum disposed on the self-propelled device. Because the support frame assembly in the use position is wider than the dimension of a width permissible on public roads, the support frame assembly is subdivided into a plurality of frame assembly portions, which are connected to one another by joints. The frame assembly portions, by way of a cable pull, can folded up in the horizontal direction, from a use position to a transport position with a width dimension permissible for use on public roads. In the use position, the rigid support frame assembly extends at least approximately in a direction transverse to the direction of travel. A rotating movement of the support frame assembly in a full circle is not provided.

Known from document DE 42 09 332 A1 is a spray unit for dispensing pesticides. An outrigger system on which are located a number of dispensing nozzles are disposed on a vehicle in order to treat a land area. The outrigger system is rotatable by up to 180° so as to be able to reduce the dispensing width when an obstacle has to be bypassed, when narrower strips are worked, or when turning around at the end of a field.

Thus, there exists a need in the art to increase the dispensing output of a self-propelled device while simultaneously avoiding soil erosion and a superficial run-off of water due to the irrigation procedure.

### SUMMARY OF THE INVENTION

The following objects, features, advantages, aspects, and/or embodiments, are not exhaustive and do not limit the overall disclosure. No single embodiment needs to provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

An aspect of the present disclosure is to increase the dispensing output of a self-propelled device while simultaneously avoiding soil erosion and a superficial run-off of water due to the irrigation procedure.

An aspect of the present disclosure is a self-propelled device for irrigating land areas, having a frame, a running gear, a drive device, a water supply which has a supply hose which is at least partially wound on a rotatably mounted hose drum and which is connected to a water inlet at a first end, and to a dispensing line that is rotatably mounted and connected to the water supply at a second end, and having a number of nozzles for irrigating land areas, which are connected to the dispensing line and disposed at a mutual spacing, wherein the dispensing line is designed to be foldable and is fastened to a support frame assembly which is designed to be foldable and is mounted on the self-propelled device and rotatably connected to the self-propelled device, the support frame assembly in the use position being held in a plane above the hose drum, the dispensing line and the support frame assembly being displaceable in a reciprocating manner between a use position and a transport position, and the support frame assembly for driving being operatively connected to a drive by way of which the support frame assembly is able to be rotationally driven.

When the dispensing line is designed to be foldable and is fastened to a support frame assembly of a foldable design, which is mounted on the self-propelled device and rotationally connected to the self-propelled device, the dispensing line no longer has to be of a self-supporting design. The support frame assembly makes it possible for a significantly longer dispensing line to be disposed on the self-propelled device, because significantly higher supported loads can be received by the support frame assemble across the working width of the device. The dispensing output of the device in a given temporal interval increases significantly by way of the significantly longer dispensing line, because a significantly larger working width is covered in one operating step in the same temporal interval than with a shorter dispensing line without a support frame assembly.

When both the dispensing line and the support frame assembly are designed to be foldable, these can be easily displaced in a reciprocating manner between a use position and a transport position. The dispensing line and the support frame assembly are unfolded for the irrigation work, so as to implement an ideally large working width. For road transport, the dispensing line and the support frame assembly are folded up to a smaller width again, so as to achieve an ideally small transport width.

The dispensing line is rotatably disposed on the self-propelled device by way of the support frame assembly which is rotatably connected to the self-propelled device. In this way, the dispensing line is conjointly rotated simultaneously with the rotation of the support frame assembly.

When mention is made of a support frame assembly herein, this can be designed in the manner of a lattice frame having support profiles which are suitably disposed and rigidly connected to one another. Deviating therefrom, it is also possible to absorb loads at least partially by way of steel cables, plastic material cables, tubes, deflection rollers, support eyelets and comparable construction elements which at an identical given load may be lighter than a lattice construction of rigidly interconnected profiles, have a greater elasticity under impact loads and are integrated into the construction of the support frame assembly so as to act in a direction of load.

When the support frame assembly in the use position is held in a plane above the hose drum, the support frame assembly, conjointly with the dispensing line, can freely rotate by 360°. The full rotation of the dispensing line, in particular the uninterrupted rotation in a rotating direction, enables uniform wetting of the land area to be worked with water. By combining the rotating movement of the dispensing line and the forward travel movement of the self-propelled device, this results for each nozzle attached to the dispensing line in a profile, which in the developed view is a movement of said nozzle in a helical manner across the land area to be worked, the specific design of said profile being a function of the rotating speed of the dispensing line and of the forward travel speed of the self-propelled device. However, when including the components of movement in the direction of travel of the self-propelled device, this, in any case, results in multiple overlaps of the helical profiles of the nozzle movements across the land area by way of the plurality of nozzles disposed on the dispensing line, even when the nozzles are disposed at a certain mutual spacing. As a result, proportions of the land area that have not been wetted with water in the helical movements of a first nozzle across the land area to be worked are also wetted with water by a second, third or nth nozzle. This results in a positive and uniform wetting of the land area to be worked with water.

In this design embodiment, it is possible to not attach nozzles in those regions of the dispensing line that sweep the self-propelled device in a rotating movement, without compromising the uniform wetting of the land area to be worked with water as a result. The water which would be sprayed onto the self-propelled device would not be distributed uniformly on the land area to be worked, but would run off laterally on the body of the self-propelled device and, as a result, form a track of droplets running in the direction of travel. Owing to the minerals and the particulate matter contained in the water, the continuously sprayed self-propelled device would also become increasingly visually unappealing over time. These disadvantages are avoided in this design embodiment.

Even when the hose drum is installed in the self-propelled machine in such a way that said hose drum at its highest point reaches a height which corresponds to the maximum construction height for road-legal vehicles, the support frame assembly in the use position can exceed this construction height without the self-propelled device no longer being permissible for use on a field for this reason. The rules that apply to highway traffic, in particular the height restrictions for work machines that apply to highway traffic, can be neglected off-road. Thus, the support frame assembly in its use position in the proposed design embodiment can protrude beyond the highest point of the hose drum, even when the highest point of the hose drum corresponds to the maximum permissible road-legal construction height of work machines.

Finally, the support frame assembly for driving is operatively connected to a drive by way of which the support frame assembly is able to be rotationally driven. As a result of the dedicated motorized drive of the support frame assembly, it is possible to set the dispensing line in rotation even when the dispensing line, conjointly with the support frame assembly, extends across a large working width. The nozzles no longer have to be aligned in the rotating direction but can spray the water directly in the direction of the ground. This results in reduced evaporation losses, and the efficiency of the self-propelled device is increased. The objective of keeping the supply hose tensioned during unwinding and winding can be attained in a different way than by the principle of repulsion of the water exiting the nozzles.

When the repulsion of the water exiting the nozzles is no longer needed for driving the rotating movement of the dispensing line, it is possible to allow water to exit the nozzles at a lower pressure. The exiting water is less atomized at a lower pressure, as a result of which the proportion evaporated when dispensing the water becomes smaller, and the energy requirement for providing water is reduced. The dispensing of the water becomes more efficient as a result. The technical requirements set for the water-conducting components can be reduced in accordance with the reduced load.

The motorized drive can be designed in such a way that it can be selectively operated in a bi-directional manner. Temporarily faster forward running, or temporary or permanent switching to reverse running when stationary or during travel of the self-propelled device can be utilized to prevent a collision between the support frame assembly and an obstacle, or to enable the complete irrigation of the currently worked field also in the region of the headland or in regions in which the land area to be improved is narrower than the working width of the dispensing line.

By way of the dedicated motorized drive, it is possible to set the rotating speed of the dispensing line to a selected or predefined value independently of the pressure and the flow rate of the water to be dispensed. For example, the rotating speed can be adapted to different spraying characteristics of different nozzles by way of the dedicated motorized drive, depending on which nozzles are assembled on the dispensing line. By way of a common electronic controller, it is also possible to automatically adapt the rotating speed to a current or preselected value for the forward travel speed of the self-propelled device, so as to achieve a specific spray pattern on the land area to be worked.

It is also possible to establish an irrigation map for the land area to be irrigated prior to the beginning of a work cycle, in the manner of precision farming, so as to irrigate land area proportions with a different irrigation requirement with different quantities of water. The irrigation of the land area proportions can be controlled by differently controlling the rotating speed of the dispensing line and/or the travel speed of the self-propelled device in a corresponding area-specific manner, and by an optional additional pressure control of the water to be dispensed and/or by switching on or off individual or a plurality of nozzles in an electronically controlled manner. In this way, the irrigation quantity can be reduced in depressions, for example, because the latter are often still sufficiently damp even during a comparatively long drought. The irrigation quantity can be increased in field portions with a sandy soil, because moisture contained therein rapidly seeps into the soil.

Using the device according to the invention, it is possible to irrigate a large land area in one pass despite a reduced water pressure. The lower water pressure and the resultant reduced range of the nozzles are compensated for by a larger working width of the dispensing line, which in turn is made possible by the support frame assembly. By combining a circular rotation of the dispensing line and the forward travel of the device, the temporal interval in which the land area to be irrigated is sprayed with water for the first and the last time during a pass becomes longer, so that the quantity of water dispensed by a nozzle during irrigation can be reduced without reducing the effective irrigation quantity as a result. Instead of one long-range irrigator, a plurality of nozzles are located on the dispensing line, which, during continuous rotation of the dispensing line, sweep a partial land area to be irrigated multiple times during one pass. The irrigation concept underlying the novel device is thus based on many small amounts of water being dispensed during a comparatively long temporal interval of a pass, instead of only a single quantity of water, or smaller quantities of water, being dispensed in a much smaller temporal interval, in order to achieve the advantages described. In this way, the longer temporal interval avoids torrent-like irrigation in which water runs off and causes soil erosion. The reduced water pressure now possible reduces the energy consumption of the water pump, and the evaporation losses are decreased by the lower degree of water atomization at the nozzles. Using the lower water pressure, droplets which are more similar to rain drops and better wet the ground can be applied to the ground, said droplets being better absorbed by the ground in the temporal interval during which a ground surface is irrigated during a pass.

When mention is made of a self-propelled device in this description and in the claims, this means an irrigation device which, during operation, is not carried as an attachment device by a tractor but has a dedicated propulsion drive and can move under its own force. The drive components can be fixedly installed in the frame of the device and fixedly connected to the latter. However, it is also possible to combine the drive components of the device in a drive unit, which as a drive module, is connected to the remaining device. The drive module can also be available for other applications in that said drive module is able to be separated from the device and designed so as to be able to also be operated with other work modules, independently of the device. The device can be controlled by a driver who sits on the machine; however, it is also possible to design the device in such a way that it can be operated automatically in an autonomous operating mode, without being permanently controlled by a driver.

According to one design embodiment of the invention, the support frame assembly in the transport position is at least partially displaceable in a plane below the uppermost point of the hose drum. When the support frame assembly in the transport position is at least partially displaceable in the plane below the uppermost point of the hose drum, it is possible to design the hose drum with a diameter by way of which the road-legal permissible limits of the construction height can be exploited to the maximum in the ideal case. In the transport position, the support frame assembly thus no longer has to be the component that protrudes to the maximum in the self-propelled device, when said support frame assembly is at least partially displaceable in a plane below the uppermost point of the hose drum. This has a significant influence in terms of the dispensing output of the self-propelled device. As a result of this design embodiment, the hose drum can have a larger diameter than has been considered possible to date. Because of the larger diameter of the hose drum, the supply hose can either have a larger diameter, as a result of which a larger quantity of water can flow through the supply hose in a given temporal interval at a likewise given water pressure, so that the self-propelled device can dispense a larger quantity of water on the land area to be worked in this given temporal interval, or a longer portion of an identical supply hose can be wound on the larger hose drum, as a result of which the self-propelled device can also be used on larger fields without having to be repositioned multiple times for this purpose.

The length of the supply hose determines the maximum distance which the self-propelled device can travel for irrigating a land area. At the beginning of an irrigation mission, the supply hose is typically completely wound on the rotatably mounted hose drum, and connected to a water inlet at a first end and to the dispensing line at a second end. The water to be dispensed is thus transported from the water supply to the dispensing line by way of the supply hose. When the self-propelled device is set in motion in order to irrigate a land area, that part of the supply hose that is wound on the hose drum is unwound by a length that corresponds to the distance traveled. The travel of the self-propelled device is stopped when the latter either reaches the end of the field, or the supply hose is completely unwound from the hose drum. Proceeding from this end point, the self-propelled device can irrigate the land area to be irrigated a second time during the return travel, or the self-propelled device returns as fast as possible, without any further irrigation, to the starting point, so as to proceed from the latter to irrigate another strip, or in order to be repositioned. During the return travel, the unwound supply hose is wound onto the hose drum again. It is guaranteed by way of the supply hose that the dispensing line is supplied with water along the entire distance of travel of the self-propelled device and can dispense this water on the land area to be irrigated.

According to one design embodiment of the invention, the hose drum is mounted so as to be rotatable about a rotational axis which is aligned transversely to the direction of movement of the device in the frame of the device. The direction of movement of the device is predefined by the running gear. When the rotational axis of the hose drum is aligned transversely to the direction of movement of the device, the supply hose can always be deposited on the ground of the field so as to be parallel to the direction of movement of the device, and be picked up from there in a direction which is tangential to the hose drum. As a result, additional deflection devices can be dispensed with.

According to one design embodiment of the invention, the hose drum for driving is operatively connected to a motorized drive. When the hose drum has a dedicated motorized drive, it is possible by way of the latter to control the tension of the supply hose during unwinding and winding. The motorized drive can be controlled in such a way that the wound or unwound length of the supply hose corresponds exactly to the respective distance traveled by the device. However, because the external circumference of that part of the supply hose that is wound on the hose drum continuously varies during the operation of the device, the length of a portion of the supply hose that is wound or unwound during one rotation of the hose drum also varies. In order to nevertheless keep a distance traveled by the device and the length of a portion of the supply hose that is wound or unwound in the process identical, it is advantageous to measure the tension of the supply hose resulting from the rotating movement by means of a suitable sensor system, and to control the motorized drive by way of an electronic evaluation of the continuously determined sensor data using a suitably programmed software in such a way that predefined threshold values for the tension of the supply hose are not exceeded and/or undershot. When a preselected lower threshold value for the tension of the supply hose is not undershot, this means that the supply hose is always being deposited in a straight line on the ground of the field, so as to correspond to the direction of movement of the device. As a result, the later rewinding of the supply hose is substantially facilitated. The risk of the supply hose being overloaded and potentially rupturing can be reduced by influencing the rotating speed of the hose drum by means of the motorized drive, on the one hand. On the other hand, the depositing of the supply hose in a straight line is supported.

According to one design embodiment of the invention, the dispensing line is designed as a flexible hose. The flexible hose simplifies the folding up and unfolding of the dispensing line. In the regions of joints of the support frame assembly, the flexible hose can be installed in loops by way of which length variations of the dispensing line during folding up and unfolding can be compensated for. A flexible hose is typically lighter than a metallic tube, so that the supported loads across the working width can be kept as small as possible.

According to one design embodiment of the invention, the support frame assembly is held in the frame so as to be height-adjustable between the use position and the transport position by means of a lifting device with a motorized drive. When putting the self-propelled device in operation on a field, the support frame assembly can be lifted by the lifting device from a height at which the uppermost end of the support frame assembly still adheres to the road-legal maximum permissible height to a height at which the road-legal maximum height is at least partially exceeded by components associated with the support frame assembly.

The self-propelled machine can then be operated on a field to be irrigated by the device with a support frame assembly which is in the use position and freely and permanently rotates in a rotating direction, the components of said support frame assembly at least being partially located at a height at which the maximum permissible value for the construction height of a machine moving on a highway is exceeded. In this instance, the support frame assembly is located at a height at which said support frame assembly can freely rotate also above the highest point of the hose drum. The hose drum herein, by way of its dimensions, can exploit the maximum permissible road-legal height dimensions.

In order to bring the self-propelled device back to a road-legal height at which the components of the support frame assembly are completely below the road-legal maximum height, the support frame assembly can be lowered by the lifting device from a height at which components of the support frame assembly at least partially exceed the road-legal maximum height to a height at which the support frame assembly is within the road-vehicle maximum height dimensions. A simple height adjustment by way of a linear adjustment movement is possible by way of the lifting device. The components required for a lifting device are comparatively cost-effective. The lifting device can be generated by way of a linear drive such as, for example, a hydraulic or pneumatic actuating cylinder, a sliding lattice, a chain drive, or by comparable other drive components such as electric, hydraulic or pneumatic motors with corresponding associated gear units. It can be ensured by limit switches that the corresponding terminal positions are also reached during an adjustment movement.

According to one design embodiment of the invention, at least part of the support frame assembly is foldable from the use position downward to the transport position, and from the transport position upward back to the use position, by means of a corresponding folding device. When putting the self-propelled device into operation on a field, the support frame assembly can be folded by the folding device from a height at which the uppermost end of the support frame assembly still adheres to the maximal road-legal height upward to a height at which the road-legal maximum height is at least partially exceeded by the components associated with the support frame assembly.

The self-propelled machine can then be operated on a field to be irrigated by the device with a support frame assembly which is in the use position and freely and permanently rotates in a rotating direction, the components of said support frame assembly at least being partially located at a height at which the maximum permissible value for the construction height of a machine moving on a highway is exceeded. In this instance, the support frame assembly is located at a height at which said support frame assembly can freely rotate also above the highest point of the hose drum. The hose drum herein, by way of its dimensions, can exploit the maximum permissible road-legal height dimensions.

In order to bring the self-propelled device back to a road-legal height at which the components of the support frame assembly are completely below the road-legal maximum height, the support frame assembly can be folded down by the lifting device from a height at which components of the support frame assembly at least partially exceed the road-legal maximum height to a height at which the support frame assembly is within the road-vehicle maximum height dimensions. A simple height adaptation is possible by way of a simple folding movement by way of the folding device. Those components that are height-adjustable by means of the folding movement can be connected by way of simple hinges to other components of the support frame assembly that are not adjustable in terms of their construction height by a folding movement. The components required for a folding device are comparatively cost-effective. It can be ensured by limit switches that the corresponding terminal positions have been reached after a folding movement.

It is to be noted that the lifting device for adjusting the height position of the support frame assembly may be combined with at least one folding device for folding down components of the support frame assembly. For example, the lifting device is advantageous for adjusting the overall height position of the support frame assembly, because the lifting device is driven by a motor and is thus also conceived to move comparatively high loads. The folding device, which is of a simpler design, can be used to fold up lighter and smaller components, which can be performed manually or else in a motorized manner, but with smaller and more cost-effectively designed adjustment components. As a result, the lifting device does not have to be conceived to adjust the height position of the support frame assembly over the entire height differential between the height of the uppermost point of the support frame assembly in the use position and in the transport position, but said lifting device can be restricted to a proportion of the height differential if the remaining proportion of the height differential is adjustable by way of the folding solution. The combination may be more cost-effective in production than a pure adjustment by means of a lifting device.

Depending on the design embodiment of the support frame assembly, due to technical limitations, the height differential between the height of the uppermost point of the support frame assembly in the use position and in the transport position may also be overcome only by means of a combination of a lifting device and at least one folding device. This is the case, for example, when in the instance of a maximized width of the hose drum, other components of the self-propelled device, such as, for example, tires or other components, block the available space that would be required for a complete lowering of the support frame assembly by the lifting device, or the support frame assembly structure is so high that it cannot be lowered down so far only by a lifting movement of the lifting device that the support frame assembly at the highest point adheres to the road-legal maximum height. The latter case may arise in particular when the support structure of the support frame assembly has highly protruding support posts which, for static reasons, have to have a certain height dimension in order to be able to support the proportional loads from the support frame assembly and the dispensing line that are transmitted to said support posts by way of crossmembers suspended on the latter.

According to one design embodiment of the invention, at least one foldable part of the support structure of the support frame assembly is foldable from its use position downward to a transport position by means of a corresponding folding device. The support structure is particularly suitable for a part thereof to be designed to be foldable, because the components thereof are particularly highly protruding, and the construction height of the support frame assembly can overall be significantly reduced in a simple manner when folding these particularly highly protruding components. This applies in particular to parts of the support posts and of the crossmembers connected to the latter.

According to one design embodiment of the invention, the support frame assembly so as to be distributed across its working width has a plurality of frame assembly portions which are connected to one another by joints, the support frame assembly having a central frame assembly portion which extends at least approximately parallel to and spaced apart from the rotational axis of the hose drum, the width of said central frame assembly portion corresponding at least approximately to the width of the hose drum, and further frame assembly portions which in the transport position rest laterally on the hose drum in an alignment which is parallel to the direction of travel of the device adjoining the sides of the central frame assembly portion in the direction of transverse extent of the support frame assembly. In this design of the support frame assembly having multiple elements, the central frame assembly portion in the transport position remains in a position in which it at least approximately superimposes the construction width of the hose drum. The central frame assembly portion, in the use position as well as in the transport position, can extend approximately parallel to and spaced apart from the rotational axis of the hose drum; said central frame assembly portion, in this instance, only being at a different height. Because the construction width of the hose drum is invariable in the self-propelled device, the central frame assembly portion can also have a fixed construction width. In order for the width of the support frame assembly, which in the use position extends at least approximately across the entire working width of the device, in the transport position to be able to be reduced to a width at which the road-legal dimensions are adhered to, the further frame assembly portions—which in the direction of transverse extent of the support frame assembly adjoin the sides of the central frame assembly portion—in their transport position are placed to rest laterally on the hose drum in an alignment which is parallel to the direction of travel of the device. In order for this to be enabled, the further frame assembly portions can, in each case, be connected to the central frame assembly portion by joints. In the pivoted position resting laterally on the hose drum, the width of the support frame assembly is reduced to a minimum dimension. The height position at which the support frame assembly is held in the transport position can differ from the height position at which the support frame assembly is located in the use position.

According to one design embodiment of the invention, a plurality of further frame assembly portions which are linked to one another and are connected to one another in an articulated manner at a linking point adjoin each side of the central frame assembly portion in the direction of transverse extent of the support frame assembly, whereby the mutually linked frame assembly portions in their transport position rest laterally on the hose drum and by way of the joints are held so as to be folded in a Z-shaped manner on the hose drum. In the case of comparatively large working widths of the device, it is advantageous to subdivide in each case the further frame assembly portions that adjoin the sides of the central frame assembly portion in the direction of transverse extent of the support frame assembly into a plurality of frame assembly portions which are then linked to one another and connected to one another by joints. In order to reduce the transport width of such frame assembly portions of multiple elements, it is proposed that the latter in their transport position are placed so as to rest laterally on the hose drum while folded in a Z-shaped manner. In this way, support frame assemblies in devices with a large working width can also be folded up to a width dimension by way of which the statutory parameters for highway use of a device can be adhered to.

According to one design embodiment of the invention, the central frame assembly portion is designed to be height-adjustable by way of a motor-driven lifting device, and the further frame assembly portions which adjoin each side of the central frame assembly portion in the direction of transverse extent of the support frame assembly are designed to be height-adjustable by way of the central frame assembly portion. In this design embodiment of the invention it is sufficient to connect the lifting device only to the central frame assembly portion in order to be able to overall adjust the height position of the support frame assembly. As a result, the device remains overall compact. The comparatively heavy device is overall disposed close to the center of gravity of the device, this resulting in the machine being positively balanced and easy to maneuver. Complex bracing of the lifting device and linking the latter to the further frame assembly portions adjoining each side of the central frame assembly portion in the direction of transverse extent of the support frame assembly can be dispensed with. The complexity of the height adjustment is reduced as a result, on account of which the device overall is able to be produced more cost-effectively and operated with a higher degree of reliability.

According to one design embodiment of the invention, storage consoles on which the support frame assembly in its transport position is held supported on the frame are formed on the device, and those parts of the support frame assembly that in the transport position are held by the storage consoles are able to be deposited on the storage consoles by the lifting device. Once the support frame assembly has been deposited in the storage consoles, the support frame assembly by way of the storage consoles is at least partially supported by the frame of the device. As a result, the lifting device is relieved of stress. The support frame assembly during transport is also held at additional points by way of the storage consoles, as a result of which the tendency toward critical vibration states in the device during transport is reduced. The possibility of locking those frame assembly portions that are held in a storage console to the respective storage console in order to preclude relative movements between the frame assembly portions and the device during transport can be provided.

According to one design embodiment of the invention, the vertical loads from the support frame assembly in the use position are at least partially transmitted to the frame of the device by way of the support post, and the support post is displaceable about a pivot axis to a transport position in which the support post projects beyond the hose drum by a lesser degree than in its use position. The support frame assembly can be constructed in such a way that the support post is the most highly protruding component of the construction. When the upper part of the support post is pivotable to a lower position, the construction height of the support frame assembly can be easily reduced as a result.

According to one design embodiment of the invention, the support frame assembly, in terms of its basic construction, is designed as a sliding lattice, the outer portions of the latter being supported by support ropes which are disposed obliquely in space and are connected to the support frame assembly at a first end and guided by way of the support post at a second end. A sliding lattice is a component of which the length in the direction of extent is easily variable. At the same time, the sliding lattice is able to absorb therein bearing loads, which are sufficient to hold a dispensing line at a desired height.

According to one design embodiment of the invention, the dispensing line, by way of branch line connections, is connected to a plurality of nozzles which are disposed so as to be distributed across the length of the dispensing line, a downpipe being in each case disposed between the branch line connections and the respective nozzles connected thereto, by way of which downpipe the nozzle connected thereto is held at a height that is located between the lowermost point of the support frame assembly and the land area to be irrigated. According to this design embodiment, the water flowing in by way of the supply hose is distributed by way of the dispensing line in the transverse direction to the rotation axis of the dispensing line, and fed to the nozzles, which are, however, not located at the height of the dispensing line but in a lower plane. The disadvantage resulting from the situation that the dispensing line in the use position is disposed at a very high level in order to be able to rotate above the hose drum is overcome by the proposed construction. In order to compensate for pressure losses which may result at each branch connection due to the quantity of water that is diverted there into a downpipe, individual branch connections, or a plurality of branch connections, can be equipped with adjustable throttle valves which can be set in such a way that the water exiting the nozzles connected to the dispensing line exits all nozzles at an at least approximately identical pressure.

According to one design embodiment of the invention, in the use position of the support frame assembly, the nozzles are held by the downpipes at a height at which said nozzles maintain a spacing of at least 20% of the distance between the lowermost point of the support frame assembly and the surface to be irrigated, measured in the vertical direction from the lowermost point of the support frame assembly and the land area to be irrigated. At this distance, the nozzles are located in a ground-proximal plane in which the dropping distance for the water between the nozzle and the ground area to be irrigated is only minor. As a result, the dispensed water can barely be blown away laterally by even a strong wind, and the proportion of the water ejected by the nozzles that evaporates during the dispensing remains minor, even at high temperatures.

According to one design embodiment of the invention, the downpipes are produced from a flexible plastic material. As a result of the flexible plastic material, the downpipes can easily deflect when they hit an obstacle during their rotating movement. The risk of damage and of an interrupted operation during the operation of the self-propelled device is reduced as a result.

According to one design embodiment of the invention, elastic molded elements are attached about the nozzles. The elastic molded elements are intended to avoid injury to humans or animals present in the rotating region of the dispensing line, said humans or animals potentially being hit by a nozzle during the operation of the device. When a nozzle is surrounded by an elastic molded element, it is no longer the nozzle but the elastic molded element that impacts a human or an animal. The elastic molded element can be designed as an air cushion, such as a rubber hose which is filled with air, for example, as a foam-material element, as a cotton-wool cushion, or in any other way. Such a safety precaution is, in particular, expedient when the self-propelled device is operated in an automatic mode without a driver being present.

According to one design embodiment of the invention, the water to be dispensed is ejected from the nozzles at a pressure which is below a value of 3 bar, in particular below a value of 2 bar. As a result of the nozzles being disposed on a rotationally driven dispensing line, the otherwise customary water pressure in devices for irrigating fields, which is usually approx. 5 bar, can be significantly reduced. As a result of the plurality of nozzles and the multiple passages of the plurality of nozzles over a ground area during one pass of the ground area by the device, despite the lower water pressure, the same quantity of water can be dispensed onto the ground area in a longer dispensing time than in conventional irrigation systems which operate with a shorter temporal interval for dispensing but at a higher water pressure. Sufficient quantities of water can already be dispensed at water pressures of 3 bar or less at the nozzle, in particular also of 2 bar or less. The lower operating pressure enables savings in terms of energy at the water pump that feeds water into the supply hose. Moreover, those components of the device that are exposed to the water pressure can be designed for lower operating pressures, which enables cost savings. The machine weight is also reduced as a result of the simpler components, thus saving propulsion energy, as a result of which, in particular, the support frame assembly also becomes lighter and even larger working widths are made possible.

According to one design embodiment of the invention, the device has a pressure control valve by way of which the water pressure in the dispensing line is adjustable. It is possible to vary the spray pattern of the nozzles used in the device in a desired manner by way of the pressure control valve. The quantity of water that is dispensed onto an acreage to be irrigated during one pass can also be controlled by way of the pressure controller.

According to one design embodiment of the invention, a dual rotary feedthrough for transferring the water provided by the supply hose into the dispensing line is disposed between the second end of the supply hose and a connecting line, of which the first rotary feedthrough is disposed between the hose drum and a connecting line, and the second rotary feedthrough is disposed between the connecting line and the dispensing line, and whereby both rotary feedthroughs each have a seal for the avoidance of water loss in the region of the rotary feedthroughs. The rotary feedthroughs enable the water to transition in a sealed manner between a stationary element and a rotating element. In the self-propelled device, the stationary element is the connecting line that connects the hose drum to the dispensing line. Because the dispensing line in the use position is located above the hose drum at a spacing from the latter, it is necessary to convey the water provided by way of the supply hose of the self-propelled device from the hose drum to the dispensing line by way of the connecting line. Because the hose drum as well as the dispensing line rotate during operation of the device, and only the connecting line is fixedly disposed in the device, the two rotary feedthroughs are required to avoid inappropriately high water losses at the respective transfer locations. Potential pressure losses and flow resistances in the transfer region can be minimized or entirely avoided when the rotary feedthroughs are, in each case, designed as axial interfaces.

According to one design embodiment of the invention, the device has an electronic controller by way of which the self-propelled device is able to be operated, in particular autonomously without an operator sitting on or in the device. The forward travel speed, as well as the rotating speed of the device, can, in particular be controlled by way of the electronic controller. Additionally, a steering function can also be integrated into the electronic controller. The electronic controller can also have an interface for a navigation device with position detection. Furthermore, the electronic controller can be connected to a sensor system by way of which the flawless functioning of the irrigation and the quantity of water dispensed onto the improved land area can be detected and documented. Safety functions such as, for example, ambient monitoring by sensors for identifying obstacles, identifying persons in the environment of the machine, emergency stop units, pressure monitors for the water pressure and the like can also be integrated into the electronic controller. The electronic controller can have a software that receives data from a previously established irrigation map, processes said data into actuating commands for components of the self-propelled device that are controlled by the electronic controller, and transmits these actuating commands to the corresponding components. In turn, the software can be designed to establish an irrigation map pertaining to the operative step carried out and to export said irrigation map by way of an interface. Finally, the electronic controller can also have an interface for wirelessly communicating with remote computers, so as to exchange data with the remote computers. The data exchange can be utilized in the context of a remote control of the machine and/or for optimizing the operation of the machine, for example.

According to one design embodiment of the invention, an electric motor is used as the motorized drive for the support frame assembly, for the hose drum, for the propulsion drive of the self-propelled device and/or the lifting device. The motorized drive for the support frame assembly is the drive by way of which the support frame assembly is set in rotation. The motorized drive for the hose drum is the drive by way of which the hose drum is set in rotation. The motorized drive for the propulsion drive of the self-propelled device is the drive by way of which the device is moved. The motorized drive for the lifting device is the drive by way of which of the support frame assembly is lifted or lowered. It is advantageous for all these drives when the latter can be precisely controlled and monitored in terms of their movement. Precise controlling and monitoring are possible in particular in the case of electric motors. The latter can be designed, for example, as servo motors, which, by way of corresponding software, are precisely and infinitely adjustable in terms of their movement. The electric motors have extremely short response times when it comes to starting the drive, to varying the rotating speed of the latter, to varying torques, or else to stopping the drive. Because no high drive output is required for the traveling movement of the self-propelled device, for the rotating movement of the support frame assembly, for the rotating movement of the hose drum and for the lifting movement of the lifting device, and the corresponding machine elements are normally operated at a constant rotating speed, the amount of current required by the electric motors during operation is manageable. The amounts of current required for the operation of electric motors are preferably provided by way of an accumulator which is installed in the self-propelled device and is carried on board during operation. Because the amounts of current required for the operation of the device are manageable, the accumulator can also be correspondingly cost-effective and of a small, weight-saving size. A reliably trouble-free, low-maintenance, automated and driverless operation of the device is particularly possible using the electric drives of the respective components. Electric-motor drives can be readily operated and monitored by a central electronic controller of the device.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

Further features of the invention are derived from the claims, the figures, and the present description. All features and combination of features mentioned in the description and hereunder in the description of the figures, and/or features and combinations of features shown individually in the figures can be used not only in the respective combination stated but also in other combinations or else as stand-alone features, unless there are technical impediments to doing so.

The invention will now be explained in more detail by means of a preferred exemplary embodiment and with reference to the appended drawings in which:

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

The invention is described below on the basis of the figures. The figures are only exemplary and do not restrict the general concept of the invention. In the figures:

FIG. 1 shows a view of a schematic illustration of a self-propelled device in which the support frame assembly is located in the use position;

FIG. 2: shows a view of a self-propelled device in which the support frame assembly is located in the transport position;

FIGS. 3-4 shows a version having support posts which are designed to be foldable downward to their transport position; and

FIGS. 5-7 a version having a sliding lattice as a support frame assembly.

An artisan of ordinary skill in the art need not view, within isolated figure(s), the near infinite number of distinct permutations of features described in the following detailed description to facilitate an understanding of the present invention.

Mutually corresponding components are identified by identical reference signs in all the figures as far as this is expedient. However, in the case of components which are present multiple times, not all of these components are always provided with reference signs, for reasons of clarity.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

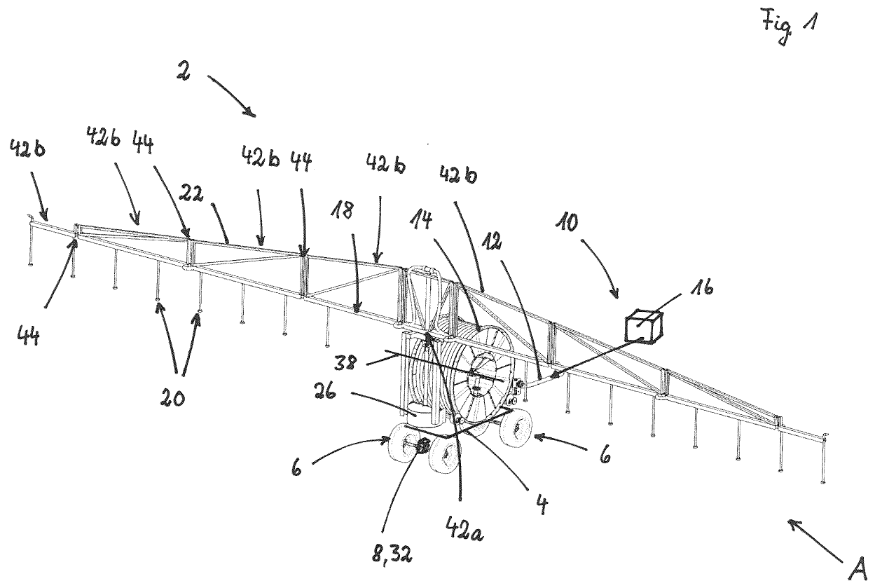

Referring now to the figures, FIG. 1 is a self-propelled device 2 for irrigating land areas, having a frame 4, a running gear 6, a drive device 8, a water supply 10 which has a supply hose 12 which is at least partially wound on a rotatably mounted hose drum 14 and which is connected to a water inlet 16, for example a pump or a connection to a fixedly installed line, at a first end, and to a dispensing line 18 that is rotatably mounted and connected to the water supply 10 at a second end, and having a number of nozzles 20 for irrigating land areas, which are connected to the dispensing line 18 and disposed at a mutual spacing. The drive device 8 in the exemplary embodiment is the drive 32 for the propulsion drive. The drive 32 can be designed as an electric motor.

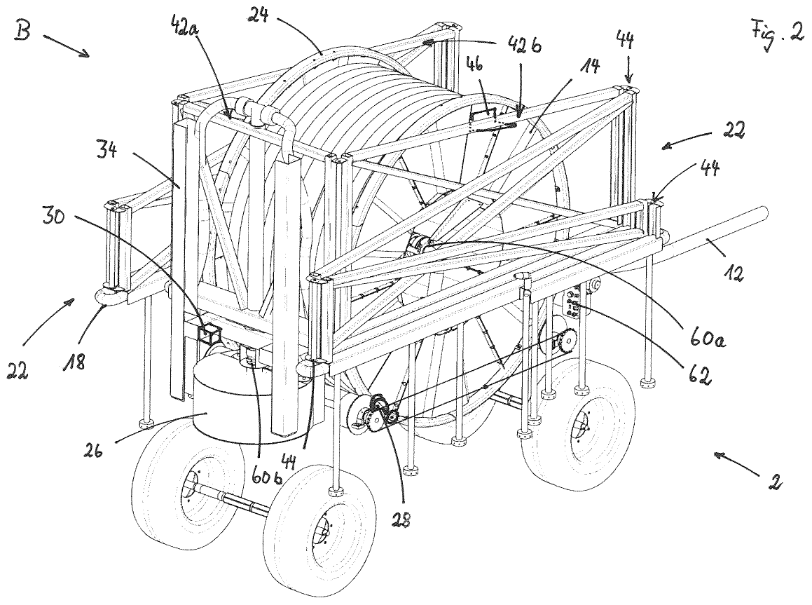

The dispensing line 18 is designed to be foldable and is fastened to a support frame assembly 22 which is likewise designed to be foldable and mounted on the self-propelled device 2 and rotatably connected to the self-propelled device 2. The dispensing line 18 and the support frame assembly 22 are displaceable in a reciprocating manner between the use position A illustrated in FIG. 1, and a transport position B, shown in FIG. 2.

The support frame assembly 22 in the use position A shown in FIG. 1 is located in a plane above the hose drum 14. In the transport position B, shown in FIG. 2, the support frame assembly 22 has been displaced completely into a plane below the uppermost point 24 of the hose drum 14. The support frame assembly 22 for driving is operatively connected to a drive 26 by way of which the support frame assembly 22 is able to be rotationally driven. The drive 26 can be an electric motor.

The hose drum 14 is mounted in the frame 4 of the device 2 so as to be rotatable about a rotational axis 38, which is aligned transversely to the direction of movement of the device 2. The hose drum 14 for driving is operatively connected to a motorized drive 28. In the exemplary embodiment shown, the drive 28 is an electric motor which, by way of a gear, drives a shaft on which the hose drum 14 is mounted on one side. A second shaft, which for driving is operatively connected to the first shaft by way of a chain drive is located on the opposite side.

The support frame assembly 22 is illustrated in a folded-up state in FIG. 2. It can be seen at the folding locations that the dispensing line 18 is designed as a flexible hose which at those folding locations is placed in loops. The support frame assembly 22 in the exemplary embodiment is held in a lifting frame. The support frame assembly 22 therein can be moved up and down so as to be height-adjustable between the use position A and the transport position B by means of a lifting device 34 with the motorized drive 30.

The support frame assembly 22 so as to be distributed across its working width has a plurality of frame assembly portions 42, which are connected to one another by joints 44. The support frame assembly 22 has a central frame assembly portion 42a, which extends at least approximately parallel to and spaced apart from the rotational axis 38 of the hose drum 14. The width of the central frame assembly portion 42a corresponds at least approximately to the width of the hose drum 14. Further lateral frame assembly portions 42b, which in their transport position B rest laterally on the hose drum 14 in an alignment which is parallel to the direction of travel of the device 2, adjoin the sides of the central frame assembly portion 42a in the direction of transverse extent of the support frame assembly 22, as is shown in FIG. 2. The plurality of further lateral frame assembly portions 42b, which adjoin each side of the central frame assembly portion 42a in the direction of transverse extent of the support frame assembly 22 are linked to one another and connected to one another in an articulated manner at a linking point, whereby the mutually linked lateral frame assembly portions 42b in their transport position B rest laterally on the hose drum 14 and by way of the joints 44 are held so as to be folded in a Z-shaped manner on the hose drum 14, as is shown for the exemplary embodiment in FIG. 2. The central frame assembly portion 42a is designed to be height-adjustable by way of a motor-driven lifting device 34. The further lateral frame assembly portions 42b, which adjoin each side of the central frame assembly portion 42a in the direction of transverse extent of the support frame assembly 22, are height-adjustable by way of the central frame assembly portion 42a.

Storage consoles 46, on which the support frame assembly 22 in its transport position is held so as to be supported on the frame, are formed on the device 2, and those parts of the support frame assembly 22 that in the transport position B are held by the storage consoles 46 are able to be deposited on the storage consoles 46 by the lifting device 34.

The device 2 has an electronic controller 62, by way of which the self-propelled device 2 is able to be operated, in particular autonomously without an operator sitting on or in the device 2.

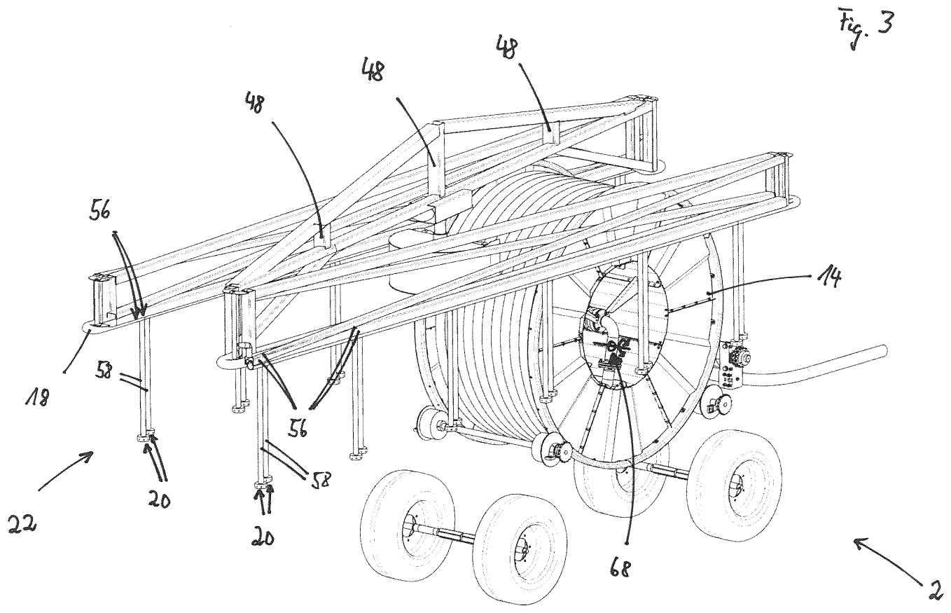

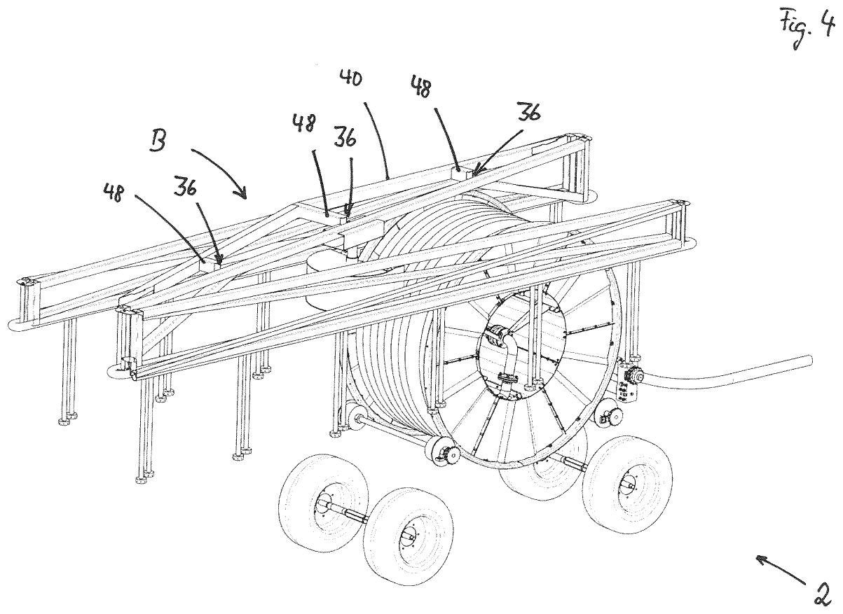

A modified embodiment of a self-propelled device 2 having a support frame assembly 22, which is lowered to the transport position B, is illustrated in FIGS. 3 and 4. The vertical loads from the support frame assembly 22 in the use position A of the latter are at least partially transmitted to the frame 4 of the device 2 by way of one or a plurality of support posts 48. In the position illustrated in FIG. 4, the support posts 48 are folded down about a pivot axis to their transport position B, in which the support posts 48 protrude beyond the hose drum 14 by a smaller dimension than in their use position A. By means of a corresponding folding device 36, at least one foldable part 40 of the support frame assembly 22, conjointly with the support posts 48 and the remaining foldable frame parts which are conjointly foldable therewith, is able to be folded from the use position A downward to the transport position B, and from the transport position B upward back to the use position A. In the latter, at least one foldable part 40 of the support structure of the support frame assembly 22 is able to be folded from the use position A downward to the transport position B by means of a corresponding folding device 36. The device 2, shown in FIG. 3, has a pressure control valve 68, by way of which the water pressure in the dispensing line 18 is adjustable.

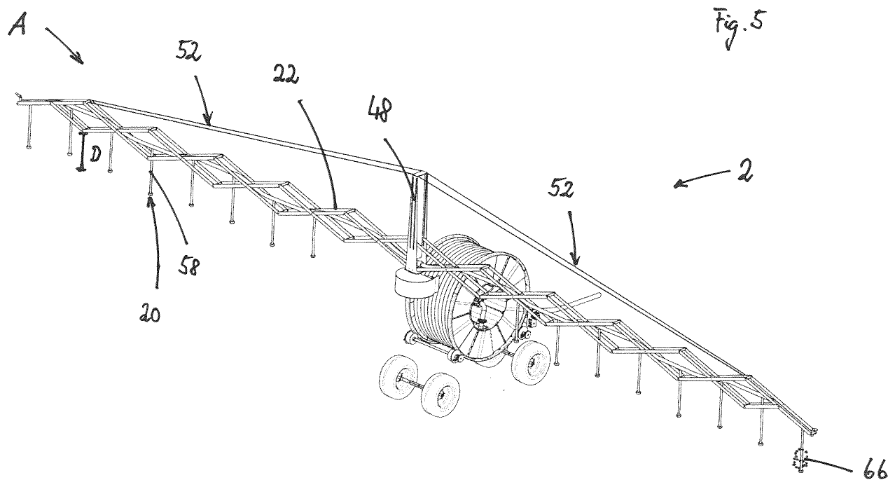

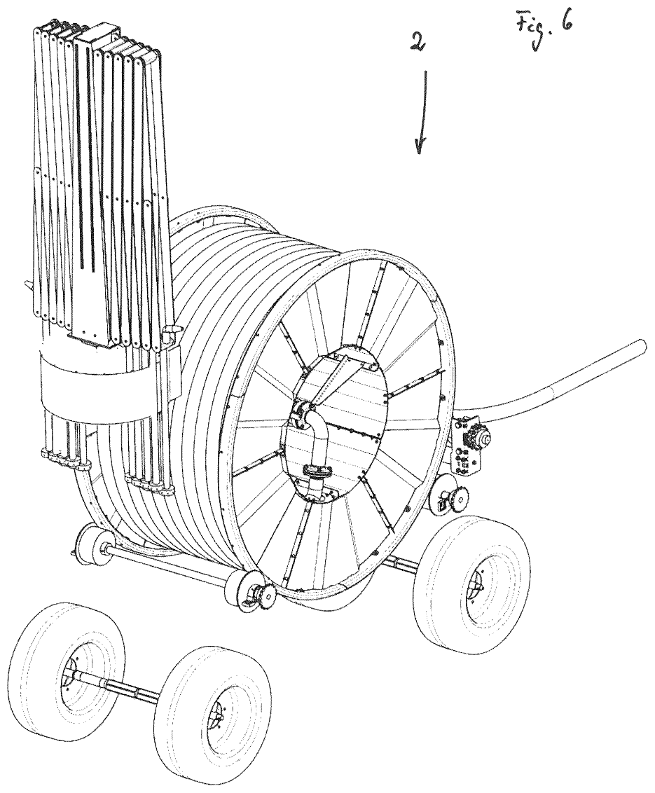

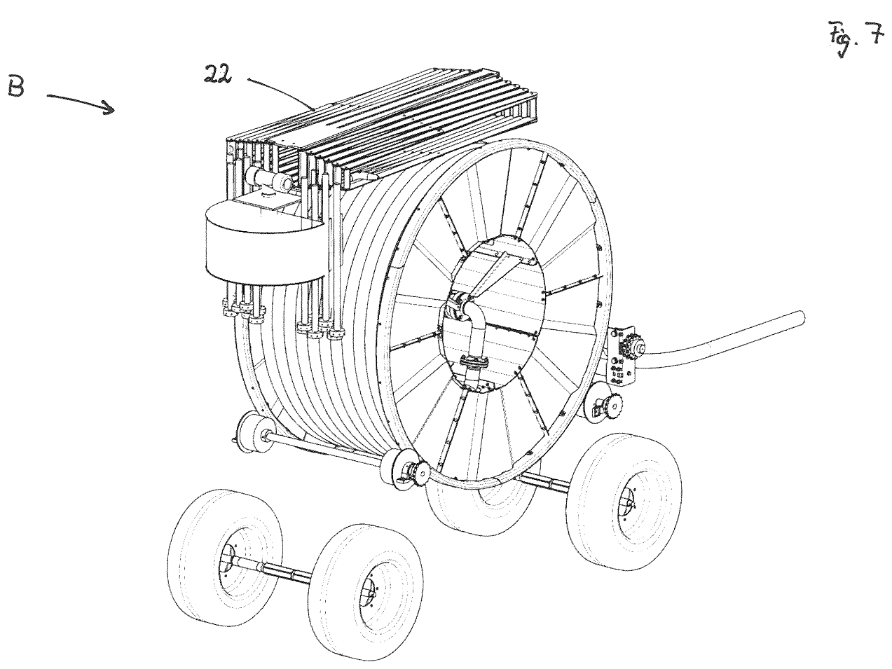

Shown in FIGS. 5, 6, and 7 is a modified embodiment of the device as a version having a sliding lattice as a support frame assembly 22, specifically with the support frame assembly 22 in the use position A in FIG. 5, and in the transport position B in FIG. 7. An intermediate position, in which the sliding lattice of the support frame assembly 22 has already been folded up but has not yet been folded downward to the position shown in FIG. 7, is shown in FIG. 6. The support frame assembly 22 in terms of its basic structure is designed as a sliding lattice 50, the outer portions thereof being supported by way of supporting ropes 52 which are disposed obliquely in space and at a first end are connected to the support frame assembly 22 and at a second end are guided by way of the support post 48.

As can be seen in FIGS. 1 to 7, the dispensing line 18 by way of branch line connections 56 is connected to a plurality of nozzles 20, which are disposed so as to be distributed across the length of the dispensing line 18, and a downpipe 58 is in each case disposed between the branch line connections 56 and the respective nozzles 20 connected thereto, by way of which downpipe 58 the nozzle 20 connected thereto is held at a height which is located between the lowermost point of the support frame assembly 22 and the land area to be irrigated. In the use position A of the support frame assembly 22, the nozzles 20 are held by the downpipes 58 at a height at which said nozzles 20 maintain a spacing of at least 20% of the distance D between the lowermost point of the support frame assembly 22 and the surface to be irrigated, measured in the vertical direction from the lowermost point of the support frame assembly 22 and the land area to be irrigated. Elastic molded elements 66 can be attached to nozzles 20, of which one example is plotted in dotted lines in FIG. 5.

In FIG. 2, two rotary feedthroughs 60 for transferring the water provided by the supply hose 12 into the dispensing line 18 are disposed between the second end of the supply hose 12 and the dispensing line 18, of which the first rotary feedthrough 60a is disposed between the hose drum 14 and a connecting line 54, and the second rotary feedthrough 60b is disposed between the connecting line 54 and the dispensing line 18. Both rotary feedthroughs 60a, 60b each have a seal for avoiding water losses in the region of the rotary feedthroughs 60a, 60b.

The invention is not limited to the exemplary embodiments described above. A person skilled in the art will have no difficulty in modifying the exemplary embodiments in a manner that is deemed suitable in order to adapt them to a specific use. The invention is not restricted to the exemplary embodiment described above. It is not difficult for those skilled in the art, using their specialist knowledge, to modify the exemplary embodiment in a manner that seems appropriate in order to adapt it to a specific application. From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 1
List of Reference Characters

| | |
|---|---|
| 2 | Self-propelled device |
| 4 | Frame |
| 6 | Running gear |
| 8 | Drive device |
| 10 | Water supply |
| 12 | Supply hose |
| 14 | Hose drum |
| 16 | Water inlet |
| 18 | Dispensing line |
| 20 | Nozzles |
| 22 | Support frame assembly |
| 24 | Uppermost point |
| 26 | Drive for support frame assembly |
| 28 | Drive for hose drum |
| 30 | Drive for lifting device |
| 32 | Drive for propulsion |
| 34 | Lifting device |
| 36 | Folding device |
| 38 | Rotational axis |
| 40 | Foldable part |
| 42 | Frame assembly portion |
| 42a | Central frame assembly portion |
| 42b | Further frame assembly portion (lateral) |
| 44 | Joints |
| 46 | Storage consoles |
| 48 | Support posts |
| 50 | Sliding lattice |
| 52 | Support ropes |
| 54 | Connecting line |
| 56 | Branch line connections |
| 58 | Downpipe |
| 60 | Rotary feedthroughs |
| 60a | First rotary feedthrough |
| 60b | Second rotary feedthrough |
| 62 | Electronic controller |
| 66 | Molded elements |
| 68 | Pressure control valve |
| A | Use position |
| B | Transport position |
| D | Distance |

### Glossary

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

1-23. (canceled)

24. A self-propelled device (2) for irrigating land areas comprising of a:
frame (4);
a running gear (6);
a drive device (8);
a water supply (10) which has a supply hose (12) which is at least partially wound on a rotatably mounted hose drum (14) and which is connected to a water inlet (16) at a first end, and to a dispensing line (18) that is rotatably mounted and connected to the water supply (10) at a second end, and having a number of nozzles (20) for irrigating land areas, which are connected to the dispensing line (18) and disposed at a mutual spacing, wherein the dispensing line (18) is designed to be foldable and is fastened to a support frame assembly (22) which is designed to be foldable and is mounted on the self-propelled device (2) and rotatably connected to the self-propelled device (2), the support frame assembly (22) in the use position (A) being held in a plane above the hose drum (14), the dispensing line (18) and the support frame assembly (22) being displaceable in a reciprocating manner between a use position (A) and a transport position (B), and the support frame assembly (22) for driving being operatively connected to a drive (26) by way of which the support frame assembly (22) is able to be rotationally driven.

25. The self-propelled device (2) for irrigating land areas according to claim 24, wherein the support frame assembly (22) in the transport position (B) is at least partially displaceable in a plane below the uppermost point (24) of the hose drum (14).

26. The self-propelled device (2) for irrigating land areas according to claim 24, wherein the hose drum (14) is mounted so as to be rotatable about a rotational axis (38) which is aligned transversely to the direction of movement of the device (2) in the frame (4) of the device (2).

27. The self-propelled device (2) for irrigating land areas according to claim 24, wherein the hose drum (14) for driving is operatively connected to a motorized drive (28).

28. The self-propelled device (2) for irrigating land areas according to claim 24, wherein the dispensing line (18) is designed as a flexible hose.

29. The self-propelled device (2) for irrigating land areas according to claim 24, wherein the support frame assembly (22) is held in the frame (4) so as to be height-adjustable between the use position (A) and the transport position (B) by means of a lifting device (34) with a motorized drive (30).

30. The self-propelled device (2) for irrigating land areas according to claim 24, wherein at least part (40) of the support frame assembly (22) is foldable from the use position (A) downward to the transport position (B), and from the transport position (B) upward back to the use position (A), by means of a corresponding folding device (36).

31. The self-propelled device (2) for irrigating land areas according to claim 30, wherein at least one foldable part (40) of the support structure of the support frame assembly (22) is foldable from its use position (A) downward to a transport position (B) by means of a corresponding folding device (36).

32. The self-propelled device (2) for irrigating land areas according to claim 24, wherein the support frame assembly (22) so as to be distributed across its working width has a plurality of frame assembly portions (42) which are connected to one another by joints (44), the support frame assembly (22) having a central frame assembly portion (42a) which extends at least approximately parallel to and spaced apart from the rotational axis (38) of the hose drum (14), the width of said central frame assembly portion (42a) corresponding at least approximately to the width of the hose drum (14), and further frame assembly portions (42b) which in their transport position (B) rest laterally on the hose drum (14) in an alignment which is parallel to the direction of travel of the device (2) adjoining the sides of the central frame assembly portion (42a) in the direction of transverse extent of the support frame assembly (22).

33. The self-propelled device (2) for irrigating land areas according to claim 32, wherein a plurality of further frame assembly portions (42b) which are linked to one another and are connected to one another in an articulated manner at a linking point adjoin each side of the central frame assembly portion (42a) in the direction of transverse extent of the support frame assembly (22), whereby the mutually linked frame assembly portions (42b) in their transport position (B) rest laterally on the hose drum (14) and by way of the joints (44) are held so as to be folded in a Z-shaped manner on the hose drum (14).

34. The self-propelled device (2) for irrigating land areas according to claim 32, wherein the central frame assembly portion (42a) is designed to be height-adjustable by way of a motor-driven lifting device (34), and the further frame assembly portions (42b) which adjoin each side of the central frame assembly portion (42a) in the direction of transverse extent of the support frame assembly (22) are designed to be height-adjustable by way of the central frame assembly portion (42a).

35. The self-propelled device (2) for irrigating land areas according to claim 29, wherein storage consoles (46) on which the support frame assembly (22) in its transport position is held supported on the frame are formed on the device (2), and those parts of the support frame assembly (22) that in the transport position (B) are held by the storage consoles (46) are able to be deposited on the storage consoles (46) by the lifting device (34).

36. The self-propelled device (2) for irrigating land areas according to claim 29, wherein the vertical loads from the support frame assembly (22) in the use position (A) of the latter are at least partially transmitted to the frame (4) of the device (2) by way of a support post (48), and the support post (48) is displaceable about a pivot axis to a transport position (B) in which the support post (48) projects beyond the hose drum (14) by a lesser degree than in its use position (A).

37. The self-propelled device (2) for irrigating land areas according to claim 36, wherein the support frame assembly (22) in terms of its basic construction is designed as a sliding lattice (50), the outer portions of the latter being supported by support ropes (52) which are disposed obliquely in space and are connected to the support frame assembly (22) at a first end and guided by way of the support post (48) at a second end.

38. The self-propelled device (2) for irrigating land areas according to claim 24, wherein the dispensing line (18) by way of branch line connections (56) is connected to a plurality of nozzles (20), which are disposed so as to be distributed across the length of the dispensing line (18), a downpipe (58) being in each case disposed between the branch line connections (56) and the respective nozzles (20) connected thereto, by way of which downpipe (58) the nozzle (20) connected thereto is held at a height that is located between the lowermost point of the support frame assembly (22) and the land area to be irrigated.

39. The self-propelled device (2) for irrigating land areas according to claim 38, wherein in the use position (A) of the support frame assembly (22), the nozzles (20) are held by the downpipes (58) at a height at which said nozzles (20) maintain a spacing of at least 20% of the distance (D) between the lowermost point of the support frame assembly (22) and the surface to be irrigated, measured in the vertical direction from the lowermost point of the support frame assembly (22) and the land area to be irrigated.

40. The self-propelled device (2) for irrigating land areas according to claim 38, wherein the downpipes (58) are produced from a flexible plastic material.

41. The self-propelled device (2) for irrigating land areas according to claim 24, wherein elastic molded elements (66) are attached about the nozzles (20).

41. The self-propelled device (2) for irrigating land areas according to claim 24, wherein the water to be dispensed is ejected from the nozzles (20) at a pressure which is below a value of 3 bar, in particular below a value of 2 bar.

43. The self-propelled device (2) for irrigating land areas according to claim 24, wherein the device (2) has a pressure control valve (68) by way of which the water pressure in the dispensing line (18) is adjustable.

44. The self-propelled device (2) for irrigating land areas according to claim 24, wherein two rotary feedthroughs (60) for transferring the water provided by the supply hose (12) into the dispensing line (18) are disposed between the second end of the supply hose (12) and the dispensing line (18), of which the first rotary feedthrough (60a) is disposed between the hose drum (14) and a connecting line (54), and the second rotary feedthrough (60b) is disposed between the connecting line (54) and the dispensing line (18), and whereby both rotary feedthroughs (60a, 60b) each have a seal for the avoidance of water loss in the region of the rotary feedthroughs (60a, 60b).

45. The self-propelled device (2) for irrigating land areas according to claim 24, wherein the device (2) has an electronic controller (62) by way of which the self-propelled device (2) is able to be operated, in particular autonomously without an operator sitting on or in the device (2).

46. The self-propelled device (2) for irrigating land areas according to claim 24, wherein an electric motor is used as the motorized drive (26, 28, 30, 32) for the support frame assembly (22), for the hose drum (14), for the propulsion drive of the self-propelled device (2) and/or the lifting device (34). 18. (New): A method for determining operating parameters of an agricultural harvesting header (4) comprising of:
utilizing software-supported image evaluation (10) of image data sets (100) of an optical sensor (6) in evaluation electronics (8), which optical sensor (6) is directed to an area (12) worked by the harvesting header (4), wherein the image evaluation (10) of the image data sets (100) generated by the optical sensor (6) is aimed at least approximately determining, as operating parameters, a value (102) for the number of lost grains (22) recognizable in the image data sets (100).
